(19) United States
(12) Patent Application Publication
(10) Pub. No.: US 2018/0154277 A1
(43) Pub. Date: Jun. 7, 2018

(54) MULTI-STAGE FLASH DESALINATION SYSTEM WITH THERMAL VAPOR COMPRESSOR

(71) Applicant: FRIEDRICH ALT, Irvine, CA (US)

(72) Inventor: FRIEDRICH ALT, Irvine, CA (US)

(21) Appl. No.: 15/368,292

(22) Filed: Dec. 2, 2016

(51) Int. Cl. B01D 1/28; B01D 3/06; B01D 5/00; B01D 1/00; B01D 3/00; C02F 1/04; C02F 1/06; C02F 1/16

(52) U.S. Cl. CPC B01D 1/2896; B01D 3/06; B01D 5/006; B01D 1/0058; B01D 3/007; C02F 2103/08; C02F 1/041; C02F 1/06; C02F 1/16; B01D 1/2812; B01D 1/289; B01D 5/0045

(57) ABSTRACT

The present invention provides a configuration of a multi-stage flash desalination system including a thermal vapor compressor and a condensate flash tank, which allows to extract a vapor from the condensate before it is returned to the power plant and to compress this vapor and use it as part of the heating steam in the brine heater, which reduces the required amount of steam supply from the power plant, while the condensate returned to the power plant at a reduced temperature allows to utilize low grade heat of exhaust gases of a steam generator to re-heat the condensate, which results in a reduced energy consumption allocated to the multi-stage flash desalination plant and an improvement of the energy efficiency of the power plant.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A SEQUENCE LISTING

Not Applicable.

### BACKGROUND OF THE INVENTION

A multi-stage flash desalination system is commonly used to produce a distillate or drinking water from seawater. Such systems are typically combined with a power plant, from which typically an extraction steam from a condensing turbine or a discharge steam from a backpressure turbine is supplied and used as heating steam.

The steam supplied from the power plant to the multi-stage flash desalination system contains energy which could be converted into electrical power and has as such a value, so that it is of advantage if the amount of steam to be supplied from the power plant can be reduced.

The steam is supplied from a power plant typically at a pressure of 2.5 to 3.0 bar (36 to 44 psi) while the heating steam pressure required in the desalination system may be typically in the range of 1.0 to 1.8 bar (15 to 26 psi). Therefore typically a steam control valve is installed to reduce the steam supply pressure as required. The required steam pressure may depend to a certain degree on the plant design criteria, but also on the operation mode of the desalination plant which may vary over an annual cycle between summer condition and winter condition and may also vary in daily cycles between day and night conditions. Downstream of the steam control valve typically a de-super heater is installed through which the temperature of the superheated steam discharging from the steam control valve is reduced by condensate injection to saturation temperature or near saturation temperature before it is used as heating steam.

The heating steam is used in a brine heater to heat a coolant, typically seawater or a re-circulating brine, to a top temperature before it enters into a multi-stage flash evaporator as flashing brine. The brine heater is typically a tube and shell heat exchanger, in which the coolant is passing through the tubes while the heating steam is condensing on the outside surface of the tubes. The condensate generated in the brine heater by condensation of the heating steam is returned to the power plant with a temperature equal or close to the saturation temperature of the heating steam, typically in the range of 100 to 115° C. (212 to 240° F.).

While a condensate returned in a power plant from a condensing steam turbine may have typically a temperature in the range of 35 to 45° C. (95 to 115° F.), such condensate is typically heated up by utilizing low grade heat of exhaust gases of a steam generator which is improving the heat rate or thermal efficiency of a power plant. As such, the condensate returned from a desalination plant at a much higher temperature is not desirable as the low grade heat from the exhaust gases can't be utilized. It would be preferred if the energy content of the condensate would be used to a maximum degree in the desalination plant, while it would be also preferred if the required steam mass flow to be supplied to the desalination plant would be reduced.

The main part of a multi-stage flash desalination system is a multi-stage flash evaporator, comprising a plurality of flash stages including a first flash stage which is operating at the highest temperature and a last flash stage which is operating at the lowest temperature. Each flash stage comprises typically a tube bundle. While a heated coolant, typically seawater or re-circulating brine, enters as flashing brine into the first flash stage at its highest temperature, it flashes down in each consecutive flash stage to a lower temperature, releases some vapor which is condensing on the tube bundles and being collected as distillate. The salt concentration of the flashing brine is increasing toward the last flash stage.

In a “once through” configuration of a multi-stage flash evaporator, typically seawater is used as a coolant, entering with its lowest temperature into the tube bundle at the last flash stage and passing through all tube bundles of the flash stages toward the first flash stage in a serial flow communication, while its temperature increases in each flash stage relative to its temperature in the previous flash stage as vapor is condensing on the outside of the tube bundles.

The most common configuration of a multi stage flash evaporator is the “brine re-circulation” concept, in which the evaporator comprises a heat recovery section and a heat rejection section. The heat rejection section comprises a plurality of flash stages, typically 2 to 4, including the last flash stage, in which typically seawater is used as a coolant for the tube bundles. The heat rejection section is designed such, that the coolant is capable to remove together with the discharging distillate and the discharging concentrated flashing brine, the majority of the heat introduced into the system by the steam supplied from the power plant. In the heat recovery section, which comprises typically more than 10 flash stages including the first flash stage, the heat released from the flashing brine is recovered by a re-circulating brine as it is passing through the tube bundles as a coolant while the vapor released from the flashing brine is condensing on the outside of the tube bundles. The re-circulating brine is a mixture of a part of the concentrated flashing brine discharging from the last flash stage of the multi-stage flash evaporator and a part of the seawater discharging from the tube bundles of the heat rejection section. The portion of the seawater used as part of the re-circulating brine, replaces primarily the amount of distillate and concentrated flashing brine discharged from the system. It may be treated by chemical dosing in order to limit scaling of the tube bundles and it may be passed through a deaerator to remove non-condensable gases in order to limit corrosion in the evaporator.

Individual types of evaporators may be further differentiated by the tube bundle configuration such as ‘long tube’ evaporators and ‘cross tube’ evaporators.

Concepts of multi-stage flash desalination systems of prior art, in which thermal vapor compressors driven by a motive steam are used, are designed to extract a vapor from a flash stage of the multi-stage flash evaporator operating at low temperature and discharging the mixture of compressed extracted vapor and the motive steam into a flash stage operating at higher temperature or into the brine heater.

As steam supplied from a power plant typically contains chemicals harmful for human consumption, this process is not suitable for drinking water production if the condensate of such steam would be mixed in the flash stages with the distillate produced from vapor releases from the flashing brine.

As the heating steam supplied from the power plant and the condensate generated in the brine heater by condensation of the heating steam have a high purity as required in the power plant for the steam generation, it is not desirable to use a configuration as per prior art where a vapor extracted with a thermal vapor compressor from a flash stage of a multi-stage flash evaporator would become a part of the heating steam in the brine heater, because a vapor extracted from a flash stage contains a relatively high quantity of salt which would contaminate the condensate in the brine heater and, when returned to the power plant it would need to be purified before it could be re-used as boiler feed water.

### BRIEF SUMMARY OF THE INVENTION

The multi-stage flash desalination system of the present invention comprises a multi-stage flash desalination system of prior art and a thermal vapor compressor and a condensate flash tank, configured to receive the condensate generated in the brine heater and to flash down the condensate and to release a vapor which is then compressed in the thermal vapor compressor, so that it can be used as a part of the heating steam in the brine heater, which reduces the required amount of steam to be supplied from the power plant, while the temperature of the condensate discharged from the condensate flash tank and returned to the power plant is reduced relative to the temperature of the condensate discharging from the brine heater, which allows in the power plant to use a low grade heat from the exhaust gases of a steam generator to warm up the returned condensate, which increases the thermal efficiency of the power plant.

In the multi-stage flash desalination system of the present invention, the thermal vapor compressor is configured to receive a motive steam and to generate a steam pressure on a discharge connection substantially equal to the heating steam pressure required in the brine heater and a suction pressure on a suction connection which is lower than the steam pressure on the discharge connection.

The thermal vapor compressor may be installed in parallel to a steam control valve in which case the thermal vapor compressor would receive a first part of a steam supplied form a power plant as motive steam, while the remaining second part of the steam supplied from the power plant would pass as a bypass steam through the steam control valve. The steam discharging from the thermal vapor compressor and the bypass steam discharging from the steam control valve would be mixed and the temperature of this mixture would be reduced in a de-super heater to a temperature as needed for the heating steam.

Alternatively, the thermal vapor compressor may be installed downstream of the steam control valve in which case substantially all the steam supplied from the power plant would pass through the steam control valve and would then enter as motive steam into the thermal vapor compressor. In this case, the steam discharging from the thermal vapor compressor would pass through the de-super heater where the temperature of the steam would be reduced as needed for the heating steam.

The condensate flash tank is configured such, that it receives the condensate generated in the brine heater by condensation of the heating steam at a temperature substantially equal to the saturation temperature corresponding with the pressure of the heating steam entering into the brine heater, while the suction side of the thermal vapor compressor is connected to the condensate flash tank, where it is generating a pressure which is lower than the pressure of the heating steam in the brine heater, which results in a flash down of the condensate and a vapor release.

The thermal vapor compressor is configured to receive the vapor released in the condensate flash tank through a suction connection and to compress this vapor substantially to the pressure as required for the heating steam. The thermal vapor compressor is further configured to mix the compressed vapor with the motive steam entering into the thermal vapor compressor, so that the steam mass flow discharging from the thermal vapor compressor is equal to the mass flow of the motive steam plus the mass flow of the vapor released from the condensate in the condensate flash tank.

As the vapor released from the condensate becomes part of the heating steam, the mass flow of the steam supplied from the power plant can be reduced.

After the flash down of the condensate and vapor release, the condensate returns to the power plant at a temperature significantly lower than the condensate temperature at the discharge of the brine heater, which allows to utilize low grade heat of exhaust gases to heat up the condensate in the power plant, while otherwise such low grade heat would be wasted.

In this configuration of the present invention the vapor received by the thermal vapor compressor from the condensate flash tank has substantially the same high purity as the steam supplied from the power plant, so that the condensate generated in the brine heater by condensation of the heating steam can be returned to the power plant substantially at the same high purity as the steam supplied form the power plant.

This brief summary has been provided, so that the nature of the invention may be understood quickly. A more complete understanding of the invention can be obtained by reference to the following detailed description of the preferred embodiments thereof in connection with the attached drawings.

### BRIEF DESCRIPTION OF THE SEVERAL VIEWS OF THE DRAWINGS

The present invention will be better understood from the following detailed description of an exemplary embodiment of the present invention, taken in conjunction with the accompanying drawings in which like reference numerals refer to like parts and in which:

FIG. 1 shows a simplified flow schematic of a multi-stage flash desalination system of prior art comprising a multi-stage flash evaporator of the “once through” type;

FIG. 2 shows a simplified flow schematic of a multi-stage flash desalination system of prior art comprising a multi-stage flash evaporator of the “brine re-circulation” type;

FIG. 3 shows a simplified schematic of a condensate flash tank and a thermal vapor compressor, which are in the present invention added into a multi-stage flash desalination system of prior art;

FIG. 4 shows a simplified flow schematic of a multi-stage flash desalination system of the present invention, wherein a condensate flash tank and a thermal vapor compressor as shown in FIG. 3 are added into the multi-stage flash desalination system of prior art as shown in FIG. 2, wherein the thermal vapor compressor is installed in parallel to a steam control valve;

FIG. 5 shows a simplified flow schematic of a multi-stage flash desalination system of the present invention, wherein a condensate flash tank and a thermal vapor compressor as shown in FIG. 3 are added into the multi-stage flash desalination system of prior art as shown in FIG. 2, wherein the thermal vapor compressor is installed downstream of the steam control valve;

FIG. 6 shows an example of a simplified flow schematic of a multi-stage flash desalination system of the present invention, wherein to a single thermal vapor compressor as shown in FIG. 4 at least one more thermal vapor compressors is added.

For a better understanding of the present invention, the flow of liquids and vapor are shown in individual Figures in form of arrows indicating in individual positions the main flow direction.

### DETAILED DESCRIPTION OF THE INVENTION

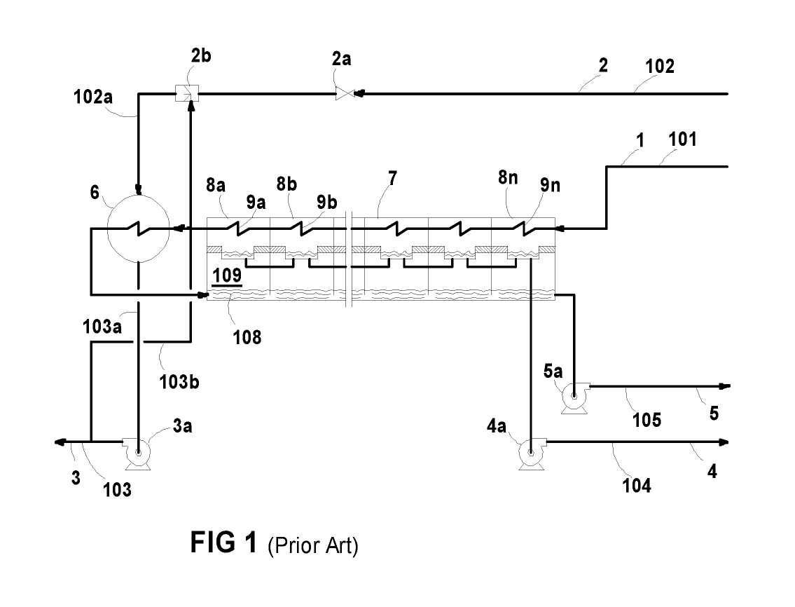

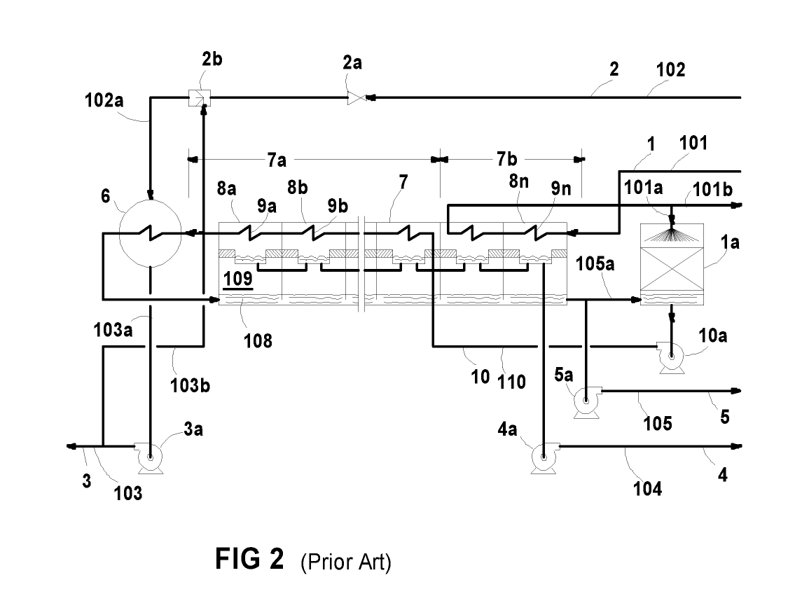

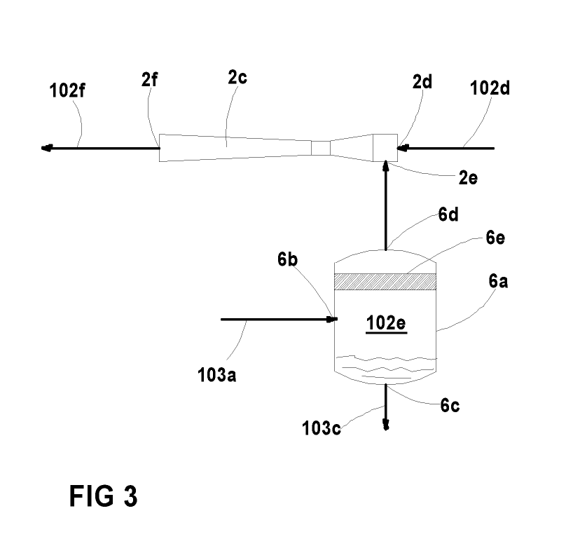

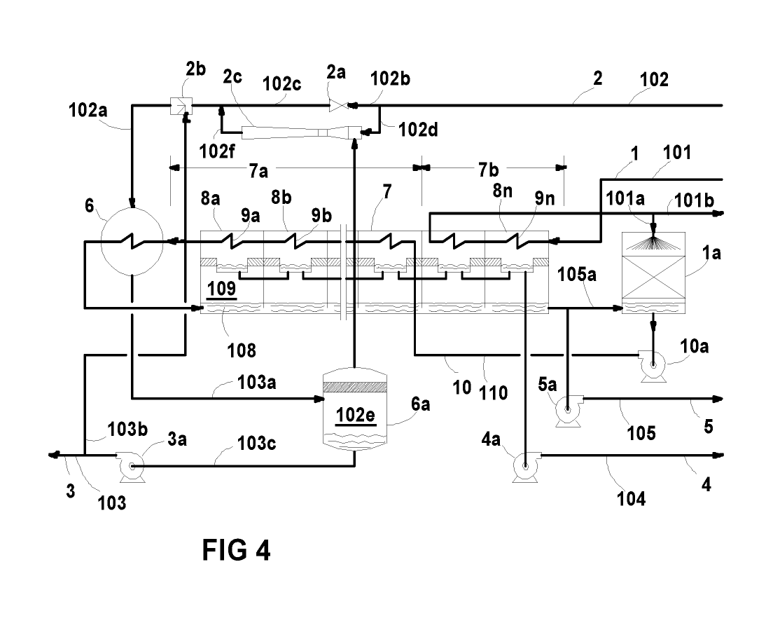

A multi-stage flash desalination system of the present invention comprises a multi-stage flash desalination system of prior art like the systems shown in FIG. 1 and FIG. 2. Further it comprises a thermal vapor compressor 2c connected to a condensate flash tank 6a as shown in FIG. 3. Examples of a multi-stage flash desalination system of the present invention are shown in FIG. 4 to FIG. 6.

Multi-stage flash desalination systems of prior art as shown in FIGS. 1 and 2 are comprising a seawater supply system 1 configured to convey a seawater 101 in the multi-stage flash desalination system, a steam supply system 2, configured to convey a steam 102 supplied from a power plant and to control the flow rate and reduce the steam pressure of this steam through a steam control valve 2a and to reduce the steam temperature of the steam discharging from the steam control valve through a de-super heater 2b as required for a heating steam 102a, a condensate system 3, comprising at least one condensate pump 3a, a distillate system 4 comprising at least one distillate pump 4a, and a brine discharge system 5, comprising at least one brine discharge pump 5a.

The multi-stage flash desalination system of prior art comprises further a brine heater 6, typically designed as a tube and shell heat exchanger, and a multi-stage flash evaporator 7, which comprises a plurality of flash stages 8a, 8b . . . to 8n, each comprising a tube bundle 9a, 9b . . . to 9n.

The brine heater 6 is configured to receive a coolant discharging from the tube bundle 9a located in the first flash stage 8a and to convey this coolant through the tubes of the brine heater. Further the brine heater is configured to receive the heating steam 102a and to condense the heating steam 102a on the tubes of the brine heater to increase the temperature of the coolant passing through the tubes of the brine heater to a top temperature. Further, the first flash stage 8a of the multi-stage flash evaporator 7 is configured to receive the coolant discharging from the brine heater 6 at the top temperature as flashing brine 108.

Further, the flash stages 8a, 8b . . . 8n of the multi-stage flash evaporator are configured to allow the flashing brine 108 to flash down in each consecutive flash stage to a lower temperature and to release a vapor 109 and to condense this vapor on the tube bundles located in the individual flash stages and to collect the condensed vapor as a distillate 104. The distillate system 4 is configured to convey the distillate 104 from the last flash stage 8n out of the multi-stage flash desalination system.

Further, the steam supply system 2 is configured to control the flow rate and to reduce the steam pressure of the steam 102 supplied from the power plant through the steam control valve 2a as required for the heating steam 102a and to reduce the steam temperature of the steam discharging from the steam control valve 2a to a temperature as required for the heating steam 102a by injection of a condensate 103b in the de-super heater 2b, wherein the condensate system 3 is configured to branch off the condensate 103b from a condensate 103a generated by condensation of the heating steam 102a in the brine heater 6, wherein the condensate system 3 is further configured to convey the condensate 103 remaining after the condensate 103b is branched off from the condensate 103a, at a temperature substantially equal to the saturation temperature of the heating steam 102a, back to the power plant.

In case of a “once through” configuration as shown in FIG. 1, the tube bundle 9n located in the last flash stage 8n of the multi-stage flash evaporator 7 is configured to receive the seawater 101 conveyed through the seawater supply system 1 as a coolant while all tube bundles located in the flash stages 8a, 8b . . . 8n are configured to convey this coolant through all tube bundles from tube bundle 9n to tube bundle 9a in a serial flow communication. Further, the brine discharge system 5 is configured to convey the remaining flashing brine from the last flash stage 8n of the evaporator 7 as a concentrated brine 105 out of the multi-stage flash desalination system.

In the case of a “brine recirculation” configuration as shown in FIG. 2, the multi-stage flash evaporator 7 is divided into a heat recovery section 7a and a heat rejection section 7b.

The heat rejection section 7b comprises a plurality of typically two to four flash stages including the last flash stage 8n with the tube bundle 9n. The tube bundle 9n located in the last flash stage 8n of the multi-stage flash evaporator 7 is configured to receive the seawater 101 conveyed through the seawater supply system 1 as a coolant while all tube bundles located in the heat rejection section 7b are configured to convey this coolant through all tube bundles of the heat rejection section 7b in a serial flow communication.

The heat recovery section 7a comprises typically more than 10 flash stages including the first flash stage 8a with the tube bundle 9a. The tube bundles of the heat recover section are configured to convey a re-circulating brine 110 as coolant through all tube bundles located in the heat recovery section 7a in a serial flow communication and to discharge this coolant from the tube bundle 9a located in the first flash stage 8a. A brine re-circulation system 10 comprising at least one brine re-circulation pump 10a, is configured to receive and mix a first part of seawater 101a branched off from the seawater 101 discharging from the tube bundles of the heat rejection section 7b and a first part of the flashing brine 105a discharging from the last flash stage 8n, and to convey this mixture as re-circulating brine 110 through the tube bundles of the heat recovery section 7a and the brine heater 6.

A deaerator 1a is configured to receive the first part of seawater 101a and to remove non-condensable gases from the seawater before it is used as part of the re-circulating brine 110.

The brine discharge system 5 is configured to discharge a concentrated brine 105 out of the multi-stage flash desalination system, wherein this concentrated brine 105 is the remaining part of the flashing brine discharging from the last flash stage 8n, after the first part of flashing brine 105a has been conveyed to the brine re-circulation system 10.

The seawater system 1 is configured to convey a remaining part of seawater 101b out of the multi-stage flash desalination system, wherein this remaining part of seawater 101b is the part remaining from the seawater 101 discharging from the tube bundles of the heat rejection section 7b after a first part of seawater 101a has been conveyed to the brine re-circulating system 10.

In a multi-stage flash desalination system of the present invention, the thermal vapor compressor 2c is configured to receive a motive steam 102d through a motive steam connection 2d and to discharge at a discharge connection 2f a steam 102f at a pressure substantially equal to the pressure of the heating steam 102a. Further, the thermal vapor compressor 2c is configured to generate a suction pressure at a suction connection 2e, which is lower than the pressure of the heating steam 102a. Further, the thermal vapor compressor 2c is configured to receive a vapor 102e through the suction connection 2e.

In a multi-stage flash desalination plant of the present invention as shown in FIG. 4, the thermal vapor compressor 2c is configured in a parallel flow communication with the steam control valve 2c. In this case, the thermal vapor compressor 2c is configured to receive a first part of the steam 102 supplied from the power plant as motive steam 102d, while the steam supply system 2 is configured to convey the remaining part of the steam 102 supplied from the power plant as bypass steam 102b through the steam control valve 2a. In this case, the steam control valve 2a is configured to reduce the steam pressure of the bypass steam 102b from a steam supply pressure to a lower steam pressure as required for the heating steam 102a, so that the steam 102c discharging from the steam control valve 2a and the steam 102f discharging from the thermal vapor compressor 2c will have substantially the same pressure as the heating steam 102a. Further, the steam supply system is configured to mix the steam 102c discharging from the steam control valve 2a and the steam 102f discharging from the thermal vapor compressor 2c and to pass this mixture of steam through the de-super heater 2b.

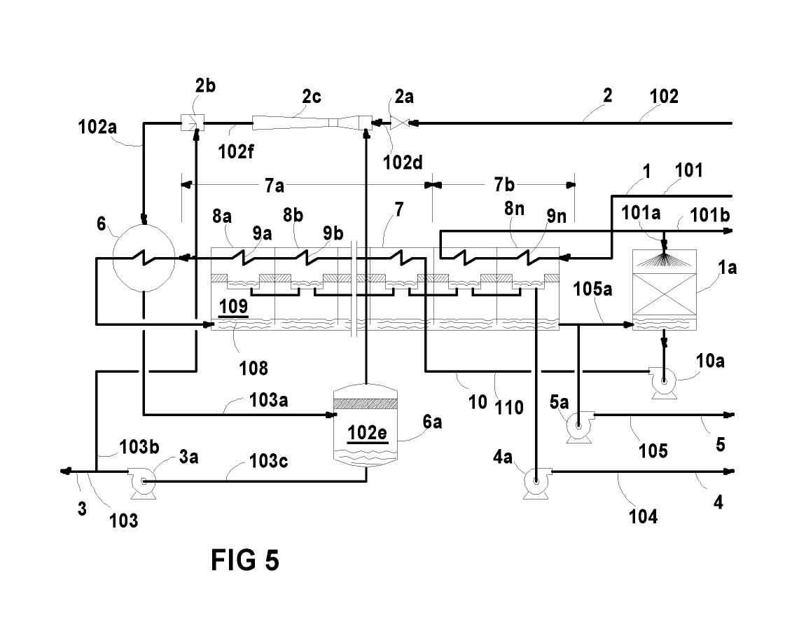

Alternatively, in a multi-stage flash desalination system of the present invention as shown in FIG. 5, the thermal vapor compressor 2c may be installed in a serial flow communication downstream of the steam control valve 2a. In this case, the steam supply system 2 is configured to pass substantially all the steam 102 supplied from the power plant through the steam control valve 2a, while the thermal vapor compressor 2c would be configured to receive the steam discharging from the steam control valve 2a as motive steam 102d at the motive steam connection 2d. Further, the steam supply system 2 would be configured to pass all the steam 102f discharging from the thermal vapor compressor through the de-super heater 2c.

In both configurations of the thermal vapor compressor 2c as shown in FIG. 4 and FIG. 5, the condensate flash tank 6a is configured to receive at a condensate inlet connection 6b the condensate 103a generated by condensation of the heating steam 102a in the brine heater 6, at a temperature which is substantially equal to the saturation temperature of the heating steam 102a. The condensate flash tank 6a and the thermal vapor compressor 2c are configured such, that through the suction connection 2e of the thermal vapor compressor 2c connected to a vapor outlet connection 6d on the condensate flash tank 6a, a pressure is generated in the condensate flash tank 6a which is lower than the saturation pressure of the condensate 103a entering into the condensate flash tank 6a, which results in a flash down of the condensate 103a and a release of the vapor 102e which is conveyed through the vapor outlet connection 6d of the condensate flash tank 6a to the suction connection 2e of the thermal vapor compressor 2c.

Further, the condensate flash tank 6a may comprise a mist eliminator 6e, which is configured to separate mist or droplets contained in the vapor 102e released from the condensate, before it is conveyed to the thermal vapor compressor 2c.

Further, the thermal vapor compressor 2c is configured to compress the vapor 102e received from the condensate flash thank 6a, to a pressure substantially equal to the pressure of the steam 102f discharging from the thermal vapor compressor and to mix the compressed vapor 102e with the motive steam 102d and to discharge both combined.

Further, the de-super heater 2b is configured to reduce the temperature of the steam passing through the de-super heater to a temperature as required for the heating steam 102a by injection of a condensate 103b.

Further, the condensate system 3 is configured to convey the condensate 103c remaining in the condensate flash tank 6a after the release of the vapor 102e, out of the condensate flash tank 6a through a condensate discharge connection 6c, and to branch off the condensate 103b and to convey it to the de-super heater 2b and to return the remaining condensate 103 to the power plant.

As the vapor 102e released from the condensate 103a becomes part of the heating steam 102a, the mass flow of the steam 102 supplied to the multi-stage flash desalination system can be reduced compared to the steam mass flow 102 required in a multi-stage flash desalination system of prior art.

As the condensate 103 is returned to the power plant at a lower temperature compared to the condensate temperature in multi-stage flash desalination systems of prior art, it allows to utilize low grade heat of exhaust gases in the power plant which otherwise would be wasted. The condensate 103 can be warm-up in the power plant by the exhaust gases of a steam generator without using additional fuel energy, while the fuel energy allocated to the steam supplied to the multi-stage flash desalination system of the present invention is reduced proportional to the reduced steam mass flow.

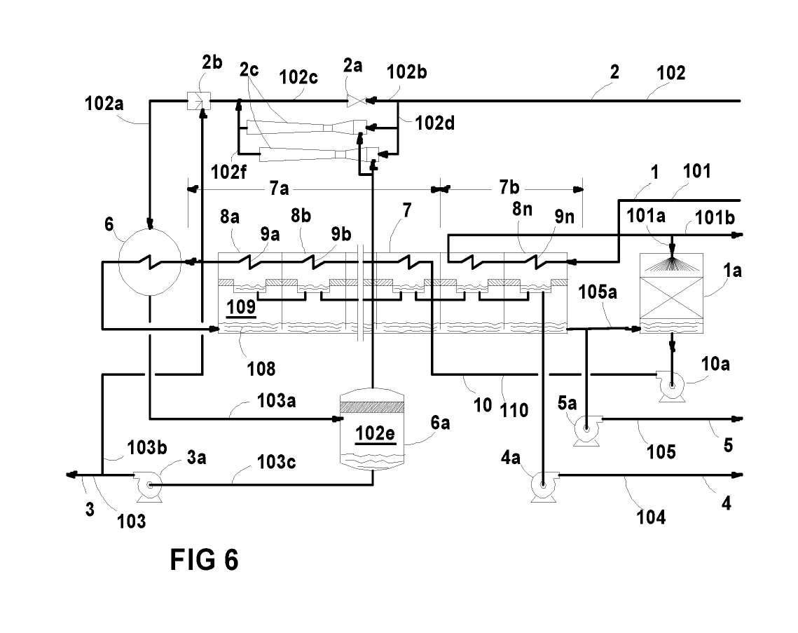

Depending on limitations of size and capacity of a thermal vapor compressor 2c and a total capacity required, in both configurations as shown in FIG. 4 and FIG. 5, at least one more thermal vapor compressor 2c may be installed as shown for example in FIG. 6, wherein all thermal vapor compressors 2c would be installed in parallel flow communication.

The multi-stage flash desalination systems described and shown in FIGS. 1 to 6, provide the general concept of systems of prior art and the present invention, which is limited to the main parts to provide an understanding of the present invention to those skilled in the field.

Details like the configuration of a condensate flash tank, a thermal vapor compressor, a multi-stage flash evaporator, etc are not shown, since those are commonly known details to those skilled in the field.

Although an exemplary embodiment of the invention has been described above by way of example only, it will be understood by those skilled in the field that modifications may be made to the disclosed embodiment without departing from the scope of the invention, which is defined by the appended claims.

What is claimed is:

1. A multi-stage flash desalination system comprising:
a multi-stage flash desalination system of prior art,
a condensate flash tank, and
a thermal vapor compressor,
wherein the multi-stage flash desalination system of prior art comprises:
a multi-stage flash evaporator, comprising a plurality of flash stages including a first flash stage and a last flash stage, and wherein a tube bundle is located in each flash stage,
a brine heater which is a tube and shell heat exchanger,
a seawater supply system configured to convey seawater in the multi-stage flash desalination system,
a brine discharge system with at least one brine discharge pump, configured to convey a concentrated brine out of the multi-stage flash desalination system,
a distillate system with at least one distillate pump, configured to convey a distillate produced in the multi-stage flash evaporator from the last flash stage of the multi-stage flash evaporator out of the multi-stage flash desalination system,
a steam supply system with a steam control valve and a de-super heater, configured to convey a steam received from a power plant, and
a condensate system with at least one condensate pump; and
wherein the multi-stage flash evaporator is configured to convey a flashing brine through all flash stages of the multi-stage flash evaporator and to allow the flashing brine to flash down gradually from a top temperature in the first flash stage to a bottom temperature in the last flash stage and to release a vapor in each flash stage and to condense this vapor on the tube bundles located in the flash stages and to collect the condensed vapor as a distillate; and
wherein the tube bundles in the flash stages are configured to convey a coolant through the tube bundles to condense the vapor released from the flashing brine on the tube bundles; and
wherein the brine heater is configured to receive a coolant discharging from the tube bundle located in the first flash stage of the multi-stage flash evaporator and to convey this coolant through the tubes of the brine heater; and
wherein the brine heater is further configured to receive a heating steam and to condense the heating steam on the tubes of the brine heater while the coolant passing through the tubes of the brine heater being heated to a top temperature, and
wherein the first flash stage of the multi-stage flash evaporator is configured to receive the coolant discharging from the brine heater as a flashing brine, and
wherein the thermal vapor compressor is configured to receive at least a part of the steam received from the power plant through the steam supply system as a motive steam through a motive steam connection; and
wherein the thermal vapor compressor is further configured to generate a pressure at a discharge connection which is substantially equal to the pressure of the heating steam in the brine heater; and
wherein the thermal vapor compressor is further configured to generate on a suction connection a suction pressure which is lower than the pressure of the heating steam in the brine heater; and
wherein the condensate flash tank is configured to receive through a condensate inlet connection the condensate generated by condensation of the heating steam in the brine heater at a temperature substantially equal to the saturation temperature of the heating steam; and
wherein the suction connection of the thermal vapor compressor is connected to a vapor outlet connection on the condensate flash tank; and
wherein the condensate flash tank and the thermal vapor compressor combined, are configured to create in the condensate flash tank a pressure substantially equal to the suction pressure created by the thermal vapor compressor, and to flash down the condensate received from the brine heater and to release a vapor from the condensate and to convey this vapor from the condensate flash tank into the thermal vapor compressor through the suction connection of the thermal vapor compressor; and
wherein the thermal vapor compressor is further configured to compress the vapor received through the suction connection to a pressure substantially equal to the pressure of the heating steam; and
wherein the thermal vapor compressor is further configured to discharge through the discharge connection a mixture of the compressed vapor and the motive steam entered into the thermal vapor compressor through the motive steam connection; and
wherein the de-super heater is configured to receive at least the steam discharging from the thermal vapor compressor, and
wherein the de-super heater is further configured to inject a condensate into the received steam to reduce the steam temperature to a temperature as required for the heating steam; and
wherein the condensate system is configured to convey the condensate remaining after the release of the vapor out of the condensate flash tank through a condensate discharge connection and to convey a first part of this condensate to the de-super heater where it is injected into the steam received by the de-super heater and to convey the remaining part of the condensate out of the multi-stage flash desalination system; and
wherein the brine heater is configured to receive the steam discharging from the de-super heater as heating steam.

2. A multi-stage flash desalination system as per claim 1, wherein
the motive steam received by the thermal vapor compressor is a first part of the steam received from the power plant through the steam supply system, while the steam supply system is configured to convey the remaining part of the steam received from the power plant as a bypass steam through the steam control valve; and
wherein the steam control valve is configured to reduce the pressure of the bypass steam to a pressure as required for the heating steam; and
wherein the de-super heater is configured to receive a mixture of the bypass steam discharging from the steam control valve and the steam discharging from the thermal vapor compressor.

3. A multi-stage flash desalination system as per claim 1, wherein
the steam supply system is configured to convey substantially all the steam received from the power plant, through the steam control valve; and
wherein the thermal vapor compressor is configured to receive substantially all the steam discharging from the steam control valve as motive steam; and
wherein the de-super heater is configured to receive the steam discharging from the thermal vapor compressor.

4. A multi-stage flash desalination system as per claim 2, comprising at least one more thermal vapor compressor, wherein all thermal vapor compressors are configured in a parallel flow communication.

5. A multi-stage flash desalination system as per claim 3, comprising at least one more thermal vapor compressor, wherein all thermal vapor compressors are configured in a parallel flow communication.

6. A multi-stage flash desalination system of claim 1, wherein
the multi-stage flash evaporator is configured to receive seawater conveyed through the seawater supply system as a coolant at the tube bundle located in the last flash stage and to convey this coolant through all tube bundles located in the flash stages in a serial flow communication and to discharge this coolant from the tube bundle located in the first flash.

7. A multi-stage flash desalination system of claim 1, comprising:
a brine re-circulation system with at least one brine re-circulation pump, and
wherein the multi-stage flash evaporator comprises:
a heat recovery section comprising a plurality of flash stages including the first flash stage; and
a heat rejection section comprising a plurality of flash stages including the last flash stage; and
wherein the heat rejection section is configured to receive the seawater conveyed through the seawater supply system as a coolant at the tube bundle located in the last flash stage and to convey this coolant through all tube bundles located in the flash stages of the heat rejection section in a serial flow communication; and
wherein the heat recovery section is configured to receive a re-circulating brine conveyed through the brine re-circulation system as a coolant and to convey this coolant through all tube bundles located in the flash stages of the heat recovery section in a serial flow communication and to discharge this coolant from the tube bundle located in the first flash stage; and
wherein the brine re-circulation system is configured to receive a mixture of a part of the seawater discharging from the tube bundles of the heat rejection section and a part of the flashing brine discharging from the last flash stage of the multi-stage flash evaporator, and to convey this mixture as re-circulating brine through the tube bundles of the heat recovery section.
